(19) United States
(12) Patent Application Publication
(10) Pub. No.: US 2015/0096970 A1
(43) Pub. Date: Apr. 9, 2015

(54) STEAM OVEN WITH QUICK RECOVERY FEATURE AND METHOD

(71) Applicant: American Equipment Corporation, Fort Wayne, IN (US)

(72) Inventor: RICHARD E. LEY, III, FORT WAYNE, IN (US)

(21) Appl. No.: 14/568,724

(22) Filed: Dec. 12, 2014

Related U.S. Application Data
(63) Continuation-in-part of application No. 13/225,928, filed on Sep. 6, 2011.
(60) Provisional application No. 61/379,803, filed on Sep. 3, 2010.

(51) Int. Cl. A21B 3/04; A21B 1/40

(52) U.S. Cl. CPC A21B 3/04; A21B 1/40
USPC 219/401

(57) ABSTRACT

A steam oven with a housing defining a cooking cavity therein and a door for accessing the cooking cavity. A water reservoir may be provided configured to hold a quantity of water that is turned to steam using a heating element. The oven may include one or more a steam supply conduits for directing steam generated in the water reservoir to the cooking cavity. A pressure sensor may be provided to detect a pressure within the cooking cavity. A control circuit regulates the heating element based on a pressure detected by the pressure sensor. However, the control circuit includes a quick recovery feature that turns on the heating element for a period of time regardless of whether the pressure within the cooking cavity is greater than a threshold pressure.

### RELATED APPLICATIONS

This application claims the benefit of U.S. Provisional Application Ser. No. 61/379,803 filed on Sep. 3, 2010, the entire disclosure of which is hereby incorporated by reference.

### TECHNICAL FIELD

This invention relates generally to steam ovens and more particularly to a steam oven with a quick recovery feature that recovers to an operating temperature quickly after the introduction of ambient temperature air into the cooking cavity, such as due to opening/closing of the oven door.

### BACKGROUND

Steam cooking offers many healthy benefits. One benefit is that food items retain their natural color and taste that may be lost with other cooking methods. Another benefit is that vitamins, minerals and other nutrients are not lost in the cooking process.

Steam ovens that cook food items using steam are well known. One type of steam oven continuously introduces steam to cook food items. With this type of steam oven, steam is continuously introduced even if the food items are fully saturated by the amount of steam already in the cooking cavity. This leads to inefficiencies in which the oven uses more water and power than really necessary. Another type of steam oven exists, which is often called “boilerless,” that does not continuously introduce steam. Instead, this type of steam oven uses a pressure switch to detect a pressure within the cooking cavity and turn off the heating element when a threshold pressure has been reached. After the heating element is turned off, the pressure within the cooking cavity eventually lowers below the threshold pressure. When this happens, the pressure switch turns back on the heating element. Accordingly, with a boilerless steam oven, the heating element is turned on/off during the cooking process depending on the pressure within the cooking cavity.

Although boilerless steam ovens tend to be efficient, these type of ovens take a longer period of time after the oven door is opened to recover, which slows the cooking process. One reason for this issue is that the pressure within the cooking cavity increases after the oven door is closed due to the introduction of ambient temperature air into the cooking cavity. This increase in pressure trips the threshold pressure detected by the pressure switch, which causes the heating element to be turned off. Although reaching the threshold pressure normally indicates that a sufficient amount of steam is already in the cooking cavity, the increase in pressure caused by opening/closing the oven door creates a “false signal” when the heating element should actually stay on. Indeed, turning off the heating element in this circumstance delays the evacuation of the ambient temperature air from the cooking cavity, which slows the cooking process. Accordingly, there is a need for a boilerless steam oven that more quickly recovers from the opening/closing of the oven door.

### SUMMARY

According to one aspect, the present invention provides a steam oven. The oven has a housing defining a cooking cavity and a water reservoir. A heating element transfers heat to the water reservoir for generating steam. The steam is directed to the cooking cavity with one or more steam supply conduits. An exhaust valve provides fluid communication between the cooking cavity and the atmosphere when a pressure within the cooking cavity is reached. The oven includes a pressure switch that controls the heating element based on a pressure within the cooking cavity. The pressure switch turns on the heating element when the pressure within the cooking cavity is less than a threshold pressure and turns off the heating element when the pressure within the cooking cavity is greater than the threshold pressure. An override circuit is provided that overrides the pressure switch so the heating element is turned on regardless of whether the pressure within the cooking cavity is greater than the threshold pressure. The override circuit turns on the heating element for a predetermined period of time or until a sensed condition, such as temperature within the cooking cavity or in gas flowing through the exhaust valve, reaches a threshold value.

In one embodiment, the oven includes a switch configured to actuate the override circuit. For example, the switch may be manually actuated by a user. Embodiments are contemplated in which the override circuit is configured to actuate responsive to detection of a pressure change in the cooking cavity that is greater than a predetermined pressure change. Depending on the circumstances, the override circuit could be configured to actuate responsive to detection of a pressure in the cooking cavity being reduced below a predetermined pressure. In some cases, where the housing includes a door for accessing the cooking cavity, the override circuit could include a door sensor configured to detect whether the door is open or closed, and circuit is actuated based on the door sensor. For example, the door could include a magnetic portion and the door sensor could be a magnetic sensor.

Embodiments are contemplated in which the exhaust valve includes a body defining a passageway therethrough that provides fluid communication between the cooking cavity and the atmosphere. The exhaust valve includes a plunger disposed in the passageway that is movable between an open position that allows flow through the passageway and a closed position that prevents flow through the passageway. Instead of relying on a spring, the plunger is configured with a weight sufficient to urge the plunger to the closed position due to gravity until a predetermined pressure within the cooking cavity is reached to overcome the weight of the plunger to open the passageway. In one embodiment, the passageway is dimensioned between approximately 1.75 inches and 2.25 inches. In some cases, the plunger has a hemispherical first end and an opposing second end with a plurality of elongated prongs that reduce lateral movement of the plunger.

According to another aspect, the invention provides a steam oven with a housing defining a cooking cavity therein and a door for accessing the cooking cavity. A water reservoir may be provided configured to hold a quantity of water that is turned to steam using a heating element. The oven may include one or more a steam supply conduits for directing steam generated in the water reservoir to the cooking cavity. A pressure sensor may be provided to detect a pressure within the cooking cavity. A control circuit regulates the heating element based on a pressure detected by the pressure sensor. The control circuit is turns on the heating element when the pressure within the cooking cavity is less than a threshold pressure and turns off the heating element when the pressure within the cooking cavity is greater than the threshold pressure. However, the control circuit includes a quick recovery feature that turns on the heating element for a predetermined period of time regardless of whether the pressure within the cooking cavity is greater than the threshold pressure. Depending on the circumstances, the quick recovery feature is actuated by: a manually actuated switch, a detection of a pressure change in the cooking cavity that is greater than a predetermined pressure change, and/or a detection of a pressure in the cooking cavity being reduced below a predetermined pressure. In some cases, the quick recovery feature is actuated by a door sensor detecting that the door has been opened or closed.

According to a further aspect, the invention provides a method for controlling a heating element in a steam oven. The method involves the step of providing a steam oven with a cooking cavity. The steam oven is one that has a heating element that transfers heat to a water reservoir to generate steam. The heating element is controlled by providing power in an interrupted manner to the heating element based on the following conditions: (a) powering the heating element if a pressure detected within the cooking cavity is less than a predetermined minimum pressure; (b) powering the heating element for a predetermined period of time after introduction of air having an ambient temperature into the cooking cavity; and (c) interrupting power to the heating element if a pressure detected within the cooking cavity is greater than a predetermined maximum pressure, subject to (b).

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a front perspective view of an example steam oven according to an embodiment of the present invention;

FIG. 2 is a left side view of the steam oven shown in FIG. 1 with a panel removed to expose interior components;

FIG. 3 is a diagrammatical view of a control circuit to control the heating element according to an embodiment of the present invention;

FIG. 4 is an exploded view of an example exhaust valve according to an embodiment of the present invention;

FIG. 5 is a graphical example of pressure within the cooking cavity during various circumstances; and

FIG. 6 is a flow chart showing example steps that may be performed during operation of a steam oven according to an embodiment of the present invention.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

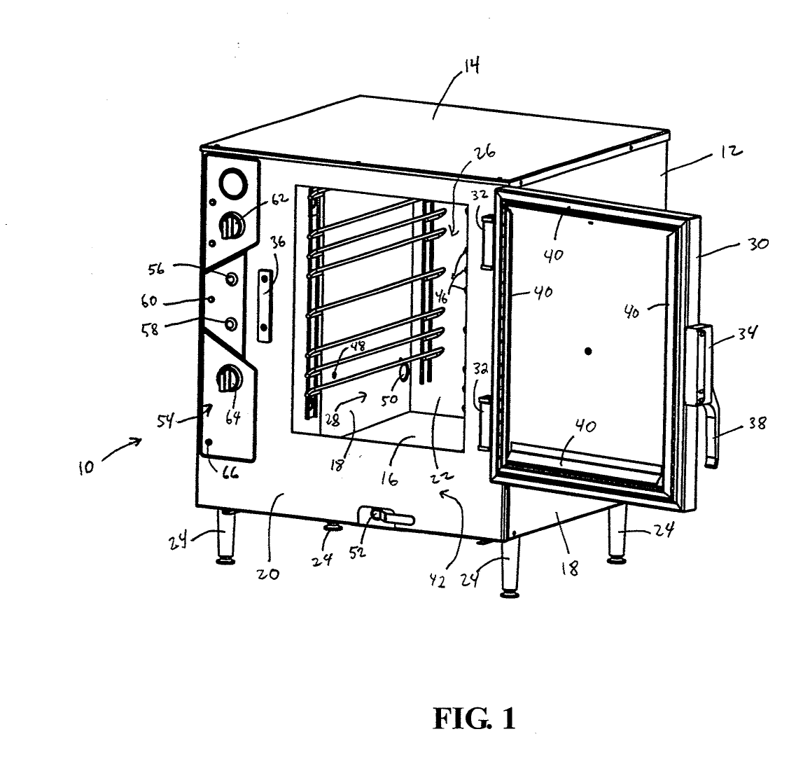

FIG. 1 shows an example steam oven 10 according to an embodiment of the present invention. In the example shown, the steam oven includes a housing 12 with a top wall 14, bottom wall 16, side walls 18, front wall 20, and rear wall 22. Typically, the walls are formed from a metal, such as stainless steel. The walls could be connected together using a variety of fasteners, such as rivets, screws, welds, and other fastening devices. In the example shown, the housing 12 is suspended above the ground by a plurality of legs 24.

In the example shown, the front wall 20 defines an opening 26 through which a cooking cavity 28 can be accessed. For example, the user could place food items in the cooking cavity 28 through the opening 26. Although this example shows the opening 26 for accessing the cooking cavity on the front wall 20, one skilled in the art should appreciate that the oven 10 could have openings on other walls to access the cooking cavity 28.

As shown, a door 30 is pivotably connected to the front wall 20 to open and close the opening 26 to the cooking cavity 28. In this embodiment, the door 30 is mounted on the front wall 20 using hinges 32 and pivots between an open position and closed position. Although the door 30 pivots about a vertical axis in example shown, the door 30 could pivot about a horizontal axis. Likewise, other arrangements could be used to move the door 30 between an open and closed position.

The door 30 includes a latch assembly 34 to securely close the door 30 using a strike plate 36. In this example, a user could open or close the door 30 by swinging the door 30 on the hinges 32 such that the latch assembly 34 is either engaged or disengaged with the strike plate 36. A handle 38 is provided in this example to allow the user to engage or disengage the latch assembly 34. Typically, the interior surface of the door 30 includes a seal 40 to prevent escape of gas from the cooking cavity 28 through the opening 26 when the door 30 is closed.

The oven 10 includes a water reservoir 42 for holding a quantity of water. Although the water reservoir 42 could be manually refilled, embodiments are contemplated in which the water reservoir 42 could be in fluid communication with a source of water and automatically refilled. For example, the oven 10 could include a low water sensor that electrically triggers a valve, such as a solenoid, to open fluid communication with the water source until the water reservoir 42 is refilled.

A heating element 44 is provided to transfer heat to the water reservoir 42 to generate steam. A plurality of steam supply conduits 46 or ports provide fluid communication between the cooking cavity 28 and the water reservoir 42 to direct steam into the cooking cavity 28. As shown, the housing 12 includes a drain valve 52 configured to drain the water reservoir 42. As discussed in more detail below, a pressure switch 48 is provided to detect a pressure within the cooking cavity 28 and control the heating element 44 based on the pressure detected within the cooking cavity 28.

In the example shown, the oven 10 includes an exhaust valve 50 for providing fluid communication between the cooking cavity 28 and the atmosphere if the pressure within the cooking cavity 28 exceeds a predetermined pressure. For example, an inlet port of the exhaust valve 50 is in fluid communication with the cooking cavity 28. Although the exhaust valve 50 is urged to a closed position to block escape of gas to the atmosphere, the pressure within the cooking cavity 28 can become sufficient to overcome the exhaust valve 50 to release gases to the atmosphere. This allows, for example, cooler air to be evacuated from the cooking cavity to increase cooking speeds.

In the example shown, a control panel 54 is provided with access on the front wall 20 of the oven 10. Although the control panel 54 is on the front wall 20 of this embodiment, it should be appreciated that the control panel could be in other locations. As shown, the control panel 54 includes an “on” switch 56 and an “off” switch 58 to turn on and turn off the oven 10, respectively. Although a separate on and off switch 56, 58 are shown in this example, one skilled in the art should understand that these switches could be combined into a single switch that both turns on and off the oven 10. As shown, the control panel 54 includes an on indicator light 60 that would illuminate if the oven 10 is turned on.

In some embodiments, the control panel 54 includes a control selector or knob 62 that allows the user to select the type of cooking that is desired. For example, the control knob 62 could be set to a “hold” setting for an untimed, continuous hold of a set temperature. A temperature selector or knob 64 could be set to the desired holding temperature in conjunction with setting the control knob 62 to the “hold” setting.

Another example control setting that could be selected by the control knob may be a setting of “CONT” to indicate an untimed continuous steam cook. If the “CONT” setting is selected using the control knob 62, the oven 10 would steam cook continuously. As discussed below, this does not mean that the heating element 44 would be continuously powered; instead, the heating element would be turned on/off depending on the pressure within the cooking cavity 28, subject to the quick recovery feature described below.

By way of another example, the control knob 62 may also have a setting that would allow a user to select the timed cook, such as a number of minutes and/or hours for a steamed cook. If the amount of time is set, the oven 10 would steam cook until the timer expires. In this example shown, the control panel 54 includes a low water indicator light 66 that would indicate the water in the water reservoir 42 is almost gone. In one example, a pressure sensor may be provided in the water reservoir 42 to determine the level of the water therein. If the pressure sensed by the pressure sensor reaches a predetermined pressure, the low water indicator light 66 may be turned on to indicate that the water should be refilled.

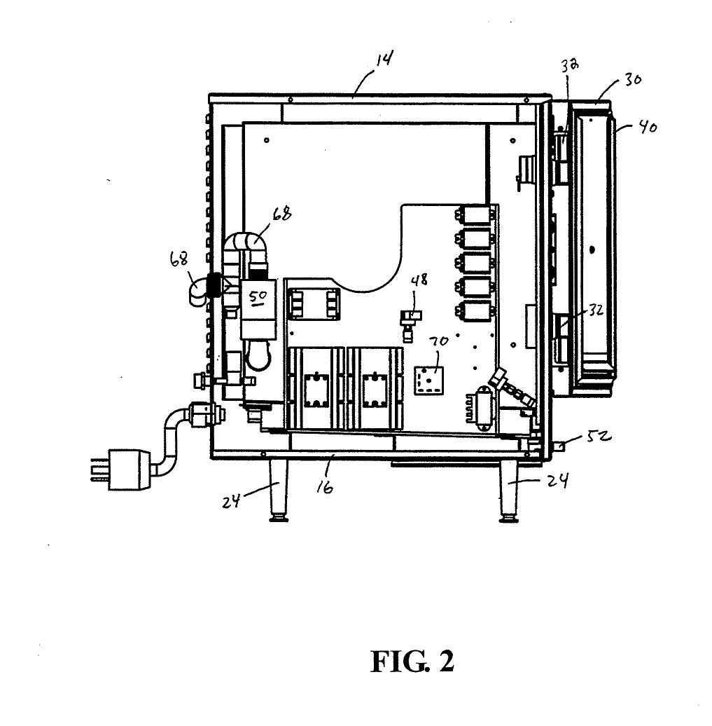

FIG. 2 shows a side view of the example steam oven 10 with a panel removed to expose certain internal components. In the example shown, the pressure switch 48 can be seen which includes a portion that extends into the cooking cavity 28 to detect the pressure therein. The exhaust valve 50 can be seen with a pipe 68 extending out to the atmosphere. As explained above, the exhaust valve 50 allows gas within the cooking chamber 28 to escape to the atmosphere if the pressure within the cooking chamber 28 exceeds a predetermined pressure. A quick recovery feature 70 can be seen in FIG. 2 which allows the heating element 44 to be turned on even if the pressure within the cooking cavity 28 exceeds a predetermined pressure. This allows a quicker recovery time so that air introduced into the cooking cavity 28 that has an ambient temperature. Other electronic components, such as relays and other control items are shown in FIG. 2, but one skilled in the art should appreciate that the operation of the oven could be performed by various circuitry and/or software and/or a combination of circuitry and software.

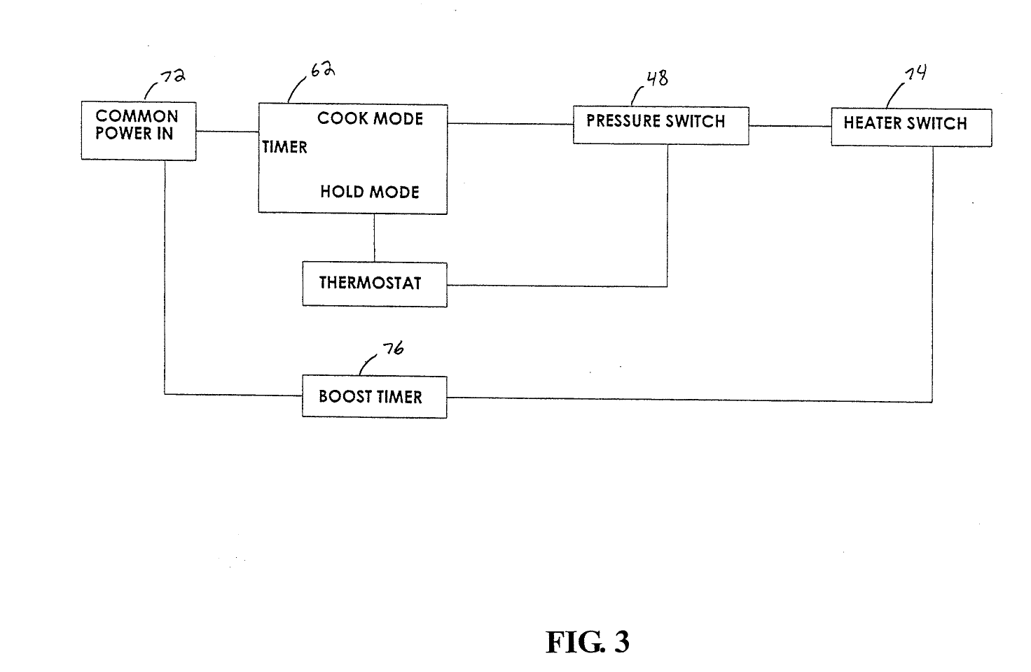

FIG. 3 shows a block diagram with various control elements that may electronically control the cooking of the oven 10. In the example shown, the electronics have a common power supply 72 to provide a source of power to the various components. The control knob 62 includes a cooking mode which may be continuous or timed.

If in the cooking mode, the heating element 44 is turned on to transfer heat to the water reservoir 42, which generates steam. This steam is introduced into the cooking cavity 28, such as using one or more steam supply conduits 46. As steam is introduced into the cooking chamber, the pressure will increase within the cooking chamber 28. The pressure switch 48 will monitor the pressure and control a heater switch 74, which could be separate or integrated with the heating element 44, if a predetermined pressure is exceeded. In other words, the pressure switch 48 will interrupt power to the heating element 44 if a threshold pressure is exceeded within the cooking cavity 28. Accordingly, the heating element 44 will reciprocate between generating steam and not generating steam depending on the pressure within the cooking cavity 28. If the continuous cook mode is selected, this will continue until the user turns off the oven 10. If in the timed cook mode, this will continue until the timer expires, which will turn off the heating element 44.

In the example shown, the control circuit includes a boost timer 76 which is also referred to as a quick recovery feature or override circuit. The boost timer 76 allows the heating element 44 to be turned on regardless of the pressure sensed by the pressure switch 48. This is important when the pressure switch 48 senses a pressure that would falsely indicate that the heating element 44 should be turned off. In one embodiment, the boost timer 76 turns on the heating element 44 for a predetermined period of time. Consider an example in which the door 30 to the oven 10 is opened and then closed. When this happens, air at an ambient temperature within the room will be introduced into the cooking cavity 28. When the door 30 is closed, this ambient temperature will expand due to the temperature within the cooking cavity 28. Although this pressure may exceed the threshold pressure that would trip the pressure switch 48 to turn off the heating element 44, there is no reason why the heating element 44 should be turned off, as this will slow the cooking process. Instead, the air at ambient temperature should be evacuated from the cooking cavity 28. Accordingly, the boost timer 76 will override the pressure switch 48 so that the heating element 44 will be turned on regardless of the pressure switch 48 for a predetermined amount of time. Since the pressure within the cooking cavity 28 will increase above the threshold pressure for the exhaust valve 50, the air with the ambient temperature will be exhausted to atmosphere through the exhaust valve 50. When the predetermined amount of time that the boost timer 76 turns on the heating element 44 is expired, the heating element 44 is again controlled by the pressure switch 48. The predetermined amount of time will vary depending on the wattage of heating element and size of the cooking cavity. For example, the predetermined amount of time may be between one to four minutes in some cases. Higher and lower times for the quick recovery feature may be used depending on the circumstances. If the control knob 62 is in the hold mode, the thermostat will maintain the temperature within the cooking cavity in conjunction with the pressure switch 48.

Embodiments are contemplated in which the quick recovery feature may override the pressure switch 48 based on a measured condition associated with the oven 10 rather than using a predetermined period of time. For example, the quick recovery feature may turn on/off the heating element 44 based on a temperature sensed within the cooking cavity 28 remote from the steam supply conduits 46 or based on a temperature of exhaust gases. The temperature may indicate that the heating element 44 should be turned on to evacuate air within the cooking cavity 28 so that steam saturates the cooking cavity 28.

Consider an example in which frozen food items are placed into the cooking cavity 28 and the door 30 closed. In this example, the user selects a timed cook for thirty minutes. Based on this selection, the heating element 44 will turn on and generate steam directed into the cooking cavity 28 via the steam supply conduits 46. Since the steam will be absorbed by the frozen food items, the pressure within the cooking cavity 28 will not initially rise, but will generally be that of atmosphere. As the cooking cycle continues, the pressure within the cooking cavity 28 will rise enough to trip the pressure switch 48, but this would slow the cooking process. At this point, the quick recovery feature may be activated to keep the heating element on. In this embodiment, rather than using a predetermined time, the quick recovery feature includes a thermocouple (or other temperature control circuit) to control when the quick recover feature should be deactivated. When the temperature rises to a sufficiently high temperature, for example, this will indicate that the cooking cavity 28 is saturated with steam and the ambient air introduced when the door 30 was opened has been evacuated from the oven cavity 28; accordingly, the heating element may be turned off and control is returned to the pressure switch 48. The temperature at which the thermocouple turns off the heating element 44 may vary depending on circumstances; however, it is believed that at a temperature greater than approximately 205° F., the thermocouple could be configured to interrupt power to the heating element 44. Although a temperature of greater than 205° F. is provided for purposes of example as a temperature in which steam would generally saturate the cooking cavity, one skilled in the art should appreciate that the thermocouple could be configured to turn off the heating element 44 at lower temperatures depending on the circumstances.

In embodiments in which a temperature is sensed to determine when the quick recovery feature should be deactivated, the thermocouple (or associated temperature sensor) could be located in various locations. For example, the thermocouple could sense a temperature within the cooking cavity 28. In such situations, however, the sensor would typically need to be remote enough from the steam supply conduits 46 to measure the overall temperate within the cooking cavity 28 instead of the steam flowing through the steam supply conduits 46. In some cases, the sensor could be outside the cooking cavity. For example, the temperature sensor could be configured to measure a temperature of exhaust gases flowing through (or out of) the exhaust valve 50.

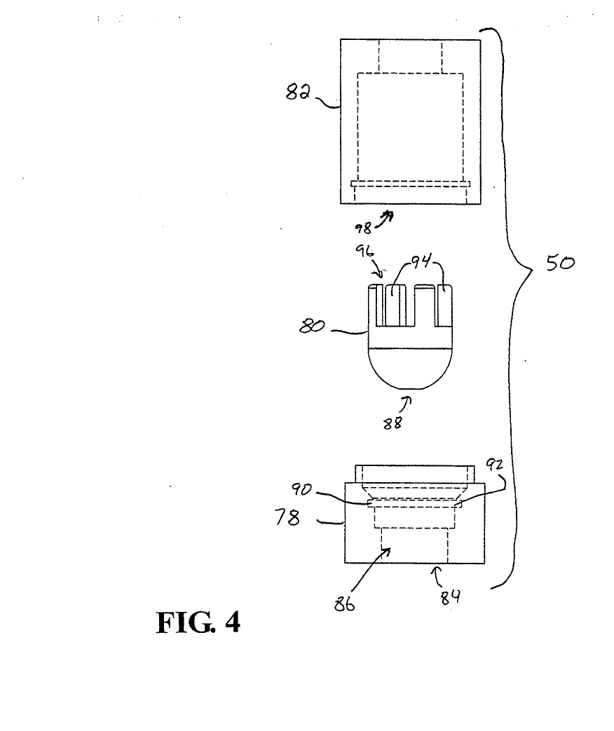

FIG. 4 shows an example exhaust valve 50 that could be used to exhaust gas from the cooking cavity 28 if the pressure exceeds a predetermined threshold. In the example shown, the exhaust valve 50 includes a base portion 78, a plunger 80, and a body 82.

As shown in this example, the base portion 78 includes an inlet port 84 that is in fluid communication with the cooking cavity 28. The base portion 78 has a passageway 86 therethrough. The passageway 86 is shaped to receive a first end 88 of the plunger with a shelf 90 that receives a seal 92 such as an o-ring. In the embodiment shown, the first end 88 of the plunger 80 has substantially hemispherical shape. The seal 92 is dimensioned to receive the first end 88 of the plunger 80. When the first end 88 of the plunger 80 is seated on the shelf 90, the plunger 80 blocks flow through the passage 86.

A plurality of prongs 94 extend from a second end 96 of the plunger. These prongs 94 are received within a passageway 98 of the body 82. These prongs 94 are dimensioned to prevent lateral movement of the plunger 80 due to interference between the prongs 94 and the interior surface of the passageway 98 in the body 82. The passageway 98 in the body 82 is in fluid communication with the atmosphere.

In the embodiment shown, the exhaust valve 50 operates without a spring to urge the plunger to a closed position. Instead, the weight of the plunger is configured to urge the plunger to be seated on the shelf 90 via gravity to block flow through the passageway 86. This prevents gas from escaping the cooking cavity 28 when the plunger 80 is in this position. The pressure within the cooking cavity 28 acts on the first end 88 of the plunger and will overcome the weight of the plunger 80 if the pressure within the cooking cavity 28 is sufficient. When this happens, the plunger 80 is unseated from the shelf 90 and moves toward the body 82, which allows flow through the passages 86, 98 and exhausts gas within the cooking cavity 28 to the atmosphere.

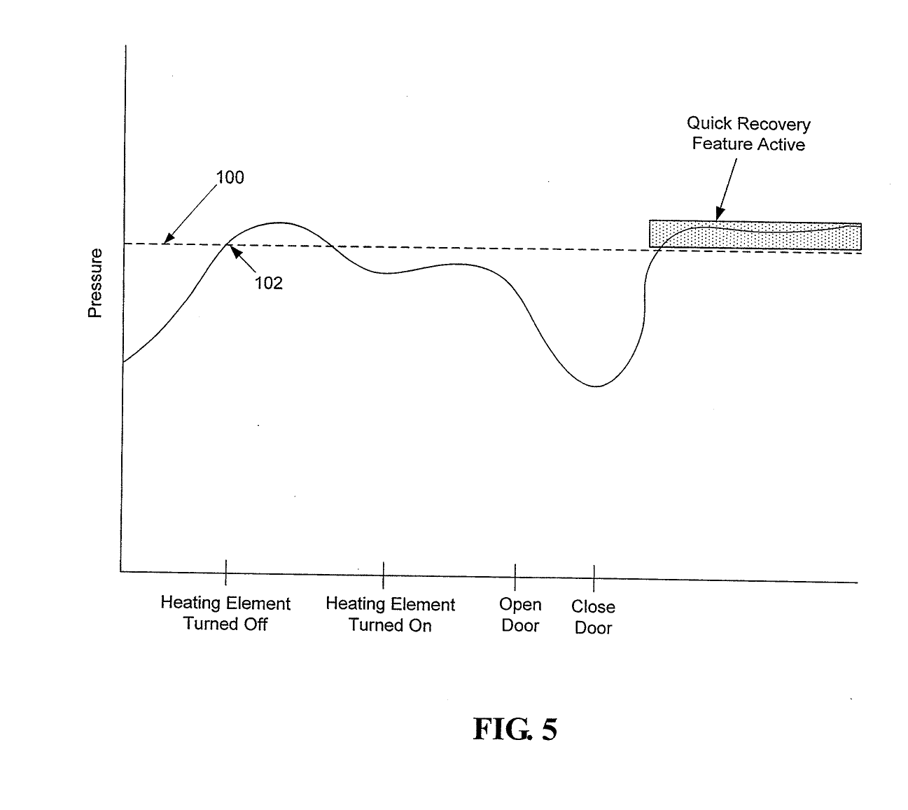

FIG. 5 is a graph showing an example of pressure within the cooking cavity 28 during operation of the oven 10. In this example, the oven 10 may already be turned on prior to the start of the graph. In any event, the pressure within the cooking cavity 28 increases due to steam being introduced therein because the heating element 44 is on, which transfers heat to water in the water reservoir 42 to generate steam. As this happens, the pressure switch 48 continuously monitors the pressure within the cooking cavity 28 for a pressure that exceeds a predetermined threshold pressure. In this example, the excess pressure amount which will cause the pressure switch 48 to turn off the heating element 44 is indicated by the dotted line 100. As can be seen, when the pressure crosses over the threshold pressure at point 102, the pressure switch turns off the heating element 44. Although the pressure may increase somewhat even after the heating element 44 is turned off, the pressure will eventually reduce until the pressure is below the threshold pressure amount indicated by dotted line 100. When this happens, the pressure switch 48 turns the heating element 44 back on to continue generation of steam.

In this example, there is an event in which the door 30 to the oven 10 is opened, such as to insert additional food into the cooking cavity 28. When this happens, the pressure drops and the air at ambient temperature in the room is introduced within the cooking cavity 28. When the door 30 is closed, the pressure within the cooking cavity 28 will increase again. Due to the introduction of air at ambient temperature within the cooking cavity 28, however, the pressure detected by the pressure switch 48 falsely indicates that the heating element 44 should be turned off. If the heating element 44 is turned off, this will delay the cooking process because there is not sufficient steam within the cooking cavity 28. Accordingly, the quick recovery feature may be activated so the heating element 44 is turned on for a predetermined period of time to evacuate the air at ambient temperature within the cooking cavity 28. This air is evacuated through the exhaust valve 50 opening due to the increase of pressure within the cooking cavity 28.

The quick recovery feature could be activated in numerous ways. Embodiments are contemplated in which the door 30 may be associated with a sensor that detects when the door opens and/or closes. When the door closes, the quick recovery feature would be automatically activated. For example, a portion of the door 30 may be magnetic and a magnetic sensor could be provided to detect when the door opens and closes. In other embodiments, a switch may be provided to allow a user to manually activate the quick recovery feature. For example, a switch could be provided on the control panel 54 that would allow the user to activate the quick recovery feature when the door is closed. In other embodiments, a change in the pressure within the cooking cavity 28 that exceeds a predetermined threshold, indicating the door has been opened, could trigger the quick recovery feature. Regardless of the manner in which the quick recovery feature is activated, it will turn on the heating element 44 for a predetermined period of time regardless of the pressure detected by the pressure switch 48. After the predetermined period of time has expired, the pressure switch 48 will continue to control the heating element 44.

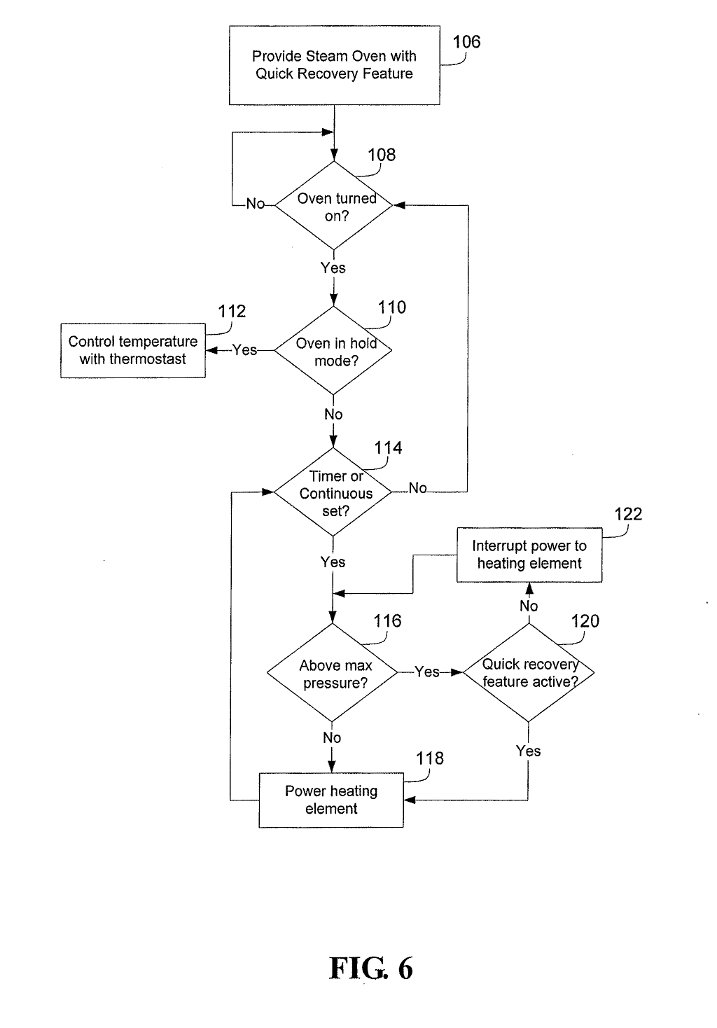

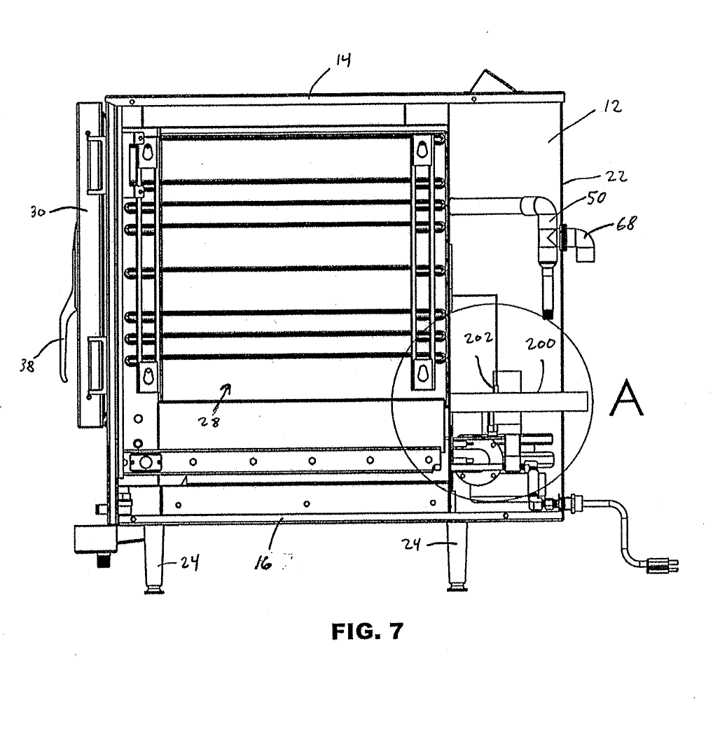

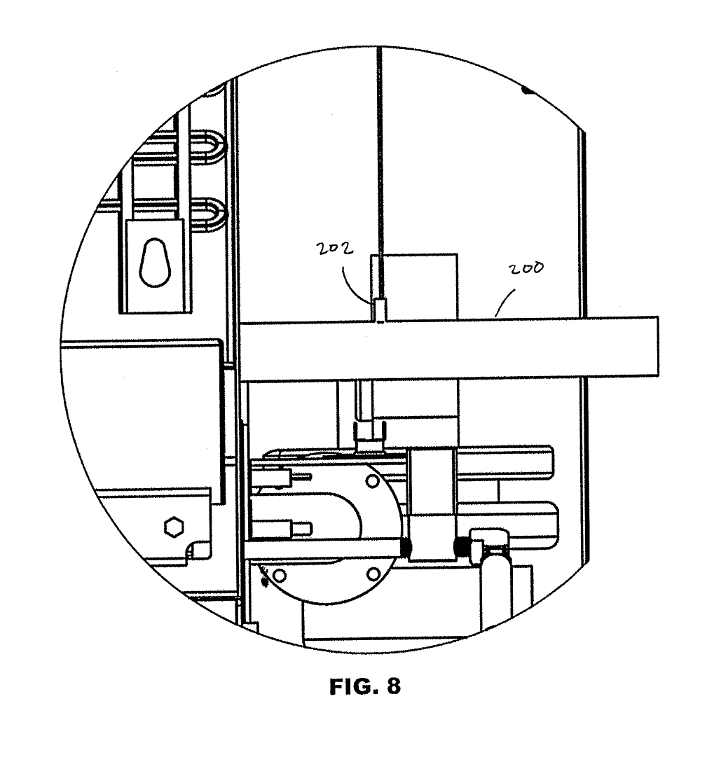

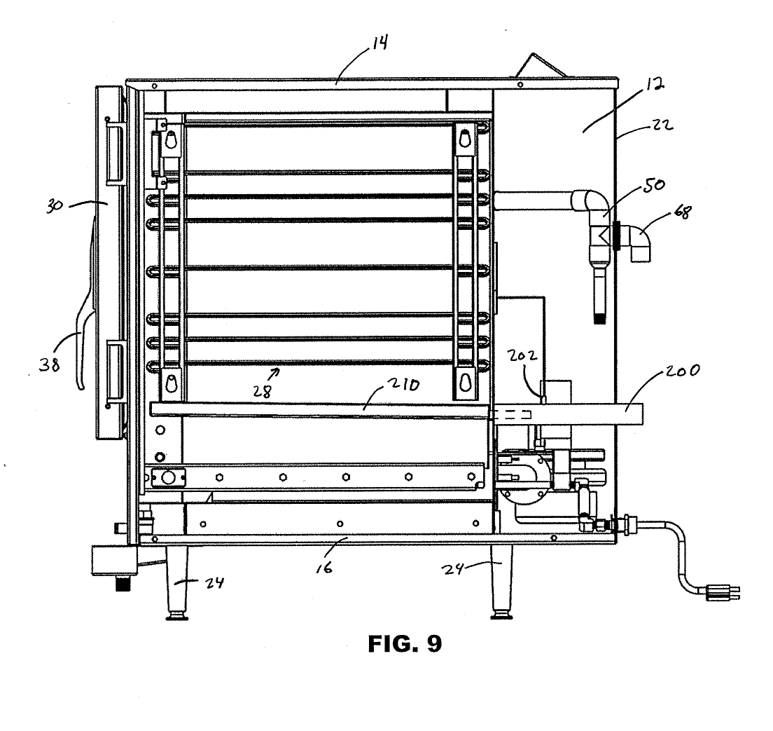

FIG. 6 is a flow chart showing a series of example steps that may be provided to operate the steam oven 10. In this example, a steam oven with a quick recovery feature like that discussed above has been provided at block 106. If the oven has been turned on, the oven could be put in hold mode, such as using the control knob 62. (Blocks 108, 110). If the oven is in hold mode, the thermostat along with the pressure switch 48 could control the temperature to the desired amount as described above. (Block 112). If the oven is not set to the hold mode, the oven could be placed in either a timed or continuous cook mode. (Block 114). If so, the pressure within the cooking cavity 28 could be detected to determine whether it exceeds a predetermined maximum pressure. (Block 116). If the predetermined maximum pressure has not yet been reached, the heating element 44 could be powered to generate steam. (Block 118). If the maximum pressure has been exceeded, however, the quick recovery feature could be activated if needed. (Block 120). If the quick recovery feature is active, the heating element should be powered for a predetermined period of time. If the quick recovery feature is not active, the power to the heating element should be interrupted so that the pressure within the cooking cavity 28 can be reduced. (Block 122).

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A steam oven comprising:
a housing defining a cooking cavity therein;
a water reservoir configured to hold a quantity of water;
a heating element configured to transfer heat to the water reservoir for generating steam;
a steam supply conduit configured to direct steam generated in the water reservoir to the cooking cavity;
an exhaust valve configured to provide fluid communication between the cooking cavity and the atmosphere when a pressure within the cooking cavity is reached;
a pressure switch configured to control the heating element based on a pressure within the cooking cavity, wherein the pressure switch turns on the heating element when the pressure within the cooking cavity is less than a threshold pressure, and wherein the pressure switch turns off the heating element when the pressure within the cooking cavity is greater than the threshold pressure; and
an override circuit configured to override the pressure switch so the heating element is turned on regardless of whether the pressure within the cooking cavity is greater than the threshold pressure, wherein the override circuit is configured to turn on the heating element for at least a predetermined period of time or until a sensed condition reaches a threshold value.

2. The steam oven of claim 1, further comprising a switch configured to actuate the override circuit, wherein the switch is manually actuated.

3. The steam oven of claim 1, wherein the override circuit is configured to turn on the heating element until a sensed temperature is reached within the cooking cavity or in exhaust gas flowing through the exhaust valve.

4. The steam oven of claim 1, wherein the override circuit is configured to actuate responsive to detection of a pressure change in the cooking cavity that is greater than a predetermined pressure change.

5. The steam oven of claim 1, wherein the override circuit is configured to actuate responsive to detection of a pressure in the cooking cavity being reduced below a predetermined pressure.

6. The steam oven of claim 1, wherein the housing includes a door for accessing the cooking cavity, wherein the override circuit includes a door sensor configured to detect whether the door is open or closed, and wherein the override circuit is actuated based on the door sensor.

7. The steam oven of claim 6, wherein the door includes a magnetic portion, wherein the door sensor is a magnetic sensor.

8. The steam oven of claim 1, wherein the exhaust valve includes a body defining a passageway therethrough that provides fluid communication between the cooking cavity and atmosphere, wherein the exhaust valve includes a plunger disposed in the passageway that is movable between an open position that allows flow through the passageway and a closed position that prevents flow through the passageway, wherein the plunger is configured with a weight sufficient to urge the plunger to the closed position due to gravity until a predetermined pressure within the cooking cavity is reached to overcome the weight of the plunger to open the passageway.

9. The steam oven of claim 8, wherein the passageway is dimensioned between approximately 1.75 inches and 2.25 inches.

10. The steam oven of claim 8, wherein the plunger has a first end and an opposing second end, wherein the first end has a substantially hemispherical shape.

11. The steam oven of claim 10, wherein the plunger has a plurality of elongated prongs extending from the second end, wherein the prongs are configured to reduce lateral movement of the plunger.

12. The steam oven of claim 11, wherein the plunger has approximately a cylindrical shape between the first end and the second end.

13. The steam oven of claim 1, further comprising a water level sensor associated with the water reservoir, wherein the water level sensor determines a level of water in the water reservoir by detecting a pressure within the water reservoir.

14. A steam oven comprising:
a housing defining a cooking cavity therein, wherein the housing includes a door for accessing the cooking cavity;
a water reservoir configured to hold a quantity of water;
a heating element configured to transfer heat to the water reservoir for generating steam;
a steam supply conduit configured to direct steam generated in the water reservoir to the cooking cavity;
a pressure sensor configured to detect a pressure within the cooking cavity;
a control circuit configured to control the heating element based on a pressure detected by the pressure sensor, wherein the control circuit is configured to turn on the heating element when the pressure within the cooking cavity is less than a threshold pressure, and wherein the control circuit is configured to turn off the heating element when the pressure within the cooking cavity is greater than the threshold pressure; and
wherein the control circuit includes a quick recovery feature configured to turn on the heating element for a predetermined period of time regardless of whether the pressure within the cooking cavity is greater than the threshold pressure.

15. The steam oven of claim 14, wherein the control circuit is configured such that the quick recovery feature is actuated by one or more of the following: a manually actuated switch, a detection of a pressure change in the cooking cavity that is greater than a predetermined pressure change, or a detection of a pressure in the cooking cavity being reduced below a predetermined pressure.

16. The steam oven of claim 14, wherein the control circuit is configured such that the quick recovery feature is actuated by a door sensor detecting that the door has been opened or closed.

17. A method for controlling a heating element in a steam oven, the method comprising the steps of:
providing a steam oven with a cooking cavity, wherein the steam oven has a heating element that transfers heat to a water reservoir to generate steam;
controlling the heating element by providing power in an interrupted manner based on the following conditions:
(a) powering the heating element if a pressure detected within the cooking cavity is less than a predetermined minimum pressure;
(b) powering the heating element for a predetermined period of time after introduction of air having an ambient temperature into the cooking cavity; and
(c) interrupting power to the heating element if a pressure detected within the cooking cavity is greater than a predetermined maximum pressure, subject to (b).

18. The method of claim 17, wherein the steam oven includes a door for access to the cooking cavity, further comprising the step of detecting whether the door has been opened or closed to determine whether air having an ambient temperature has been introduced into the cooking cavity.

19. The method of claim 17, wherein the steam oven includes a user-actuated switch for indicating an introduction of air having an ambient temperature into the cooking cavity, further comprising the step of detecting actuation of the user-actuated switch to determine whether air having an ambient temperature has been introduced into the cooking cavity.

20. The method of claim 19, further comprising the step of detecting a reduction in pressure below a predetermined pressure in the cooking cavity to determine whether air having an ambient temperature has been introduced into the cooking cavity.
